(19) United States
(12) Patent Application Publication
(10) Pub. No.: US 2010/0001033 A1
(43) Pub. Date: Jan. 7, 2010

(54) DRY FIRE WARNING DEVICE FOR HAMMER TACKER

(76) Inventor: Hsien-Cheng Chen, Taipei County (TW)

Correspondence Address: YH CHAN, 42 PIN OAKS DRIVE, PHOENIXVILLE, PA, 19460, US

(21) Appl. No.: 12/167,254

(22) Filed: Jul. 3, 2008

(51) Int. Cl. B25C 5/16; G08B 21/00

(52) U.S. Cl. 227/120; 227/156; 340/686.6; 340/815.45; 340/388.1

(57) ABSTRACT

A manual hammer tacker having a warning device involving an electric box having a buzzer or a light emitting diode (LED), and at least one battery with both conducting to each other by the electric wires to generate sound or light effect when only few U-shaped staples left during the working process. A reed switch is installed in the tacker and locates near the end route of the U-shaped staples, and is also conducted to the buzzer or the light emitting diode (LED), the battery and the metallic shell by the electric wires. Furthermore, a reed is formed on the pushing guide of the pusher assembly. At the moment when only few staples left, the reed on the pushing guide will be touched with the switch, so that the circuit will become a circuit loop and the buzzer will buzz or the light emitting diode (LED) will glitter to remind the user to reload the staples.

### BACKGROUND OF THE INVENTION

This invention relates generally to a warning device for a manual hammer tacker, more particularly to a warning device which can be used in various types of the hammer tackers and generate a warning sound or light effect during the working process to alert the users to reload the staples when only few pieces of U-shaped staples left.

A manual hammer tacker is mainly used for driving staples into an object by hammering the tacker (like a hammer). In the process, the head of the tacker strikes down and hits the object. Due to the spring mechanism to release force, the driver of the tacker will strike on a foremost U-shaped staple, which is then conveyed to the front end of a magazine assembly. When the force achieves a level, the bottom end of the driver will keep moving downward to the bottom of the tacker until the foremost U-shaped staple has been punched and ejected out from the magazine and attached to the object. When the percussive force stops, the head of the tacker will rebound to its upper position by means of an elastomer installed inside of the tacker.

Two types of hammer tackers are broadly used nowadays. As shown in the FIGS. 1 to 6, one of them is called non-linkage hammer tacker 1 (as shown in FIGS. 1 to 3), and the other linkage built-in hammer tacker 2 (as shown in FIGS. 4 to 6). Wherein, the non-linkage hammer tacker 1, as shown in FIG. 1, includes a main body 11, a magazine assembly 12, a pusher assembly 13, a pivot pin 14 and a handle grip 15; wherein, the rear end of the main body 11 is engaged with the rear end of the magazine assembly 12 pivotally by using the pivot pin 14, so that the handle grip 15 can be sheathed onto the assembly. A leaf spring 111 is installed inside of the main body 11 to provide an elastic counterforce when the motion of punching a staple is completed. A balancing piece 112 is fixed in the inner front end of the main body 11, and a driver 113 is fixed against the balancing piece 112 to the head of the main body 11 by using a fastener 1121, to form a main feature of the hammer tacker 1. A staple magazine 121 is formed along the longitudinal length of the magazine assembly 12, which provides U-shaped staples 16 to be fed from its transverse direction along the staple magazine 121. Meanwhile, the staples 16 are always pushed ahead elastically by virtue of the pusher assembly 13, so that a foremost staple 16 will always situate at the ejecting position of the tacker 1 for providing a hammering motion driven by the driver 113. The main function of the pusher assembly 13 is used for pushing the U-shaped staples 16 forward in the magazine assembly 12 elastically, which contains a pushing rod 131, a pushing guide 132, a rear cover 133 and an adjustable spring 134 that sheathed on the pushing rod 131; wherein, the pushing rod 131 and the rear cover 133 are welded to form as one, and the pushing guide 132 is attached to the front end of the adjustable spring 134, so the pushing guide 132 can be slid along the pushing rod 131 elastically. In addition, the length of the adjustable spring 134 is also longer than that of the pushing rod 131, so that the pushing guide 132 will be always pushed forwardly to the front by means of the tension of the adjustable spring 134. Since the width of cross-section of the staples 16 is the same as the pushing guide 132, when the pusher assembly 13 is assembled to the magazine assembly 12, its pushing guide 132 will also mount on the rail of the staple magazine 121 which will then be pushed forwardly by the adjustable spring 134. As such, the U-shaped staples 16 are always loaded in the staple magazine 121, while the foremost staple 16 will always be pushed forward to the front ejecting position 114 of the staple magazine 121 (as shown in FIG. 2).

For illustration purpose, FIG. 2 shows a cross-sectional view of the non-linkage hammer tacker 1, illustrating the position of the tacker 1 before it is hammered, and FIG. 3 shows a cross-sectional view of the non-linkage hammer tacker 1, illustrating the position of the tacker after it is hammered. As shown in the FIG. 2, before the staple 16 is punched, the assembly of the main body 11 and the magazine assembly 12 are located at the starting position and its head stays in an opening wide position; meanwhile, the staples 16 are being pushed forward to the front ejecting position 114 of the staple magazine 121 by means of the pusher assembly 13, which is functioned by the tension of the adjustable spring 134; as to the driver 113 which is located at the upper position of the ejecting position 114. When the user holds the handle grip 15 of the tacker 1 to hammer an object, as shown in FIG. 3, the head of the tacker 1 strikes down and hits the object. With the transmission of the force, the driver 113 of the main body 11 strikes the foremost U-shaped staple 16 which is conveyed to the front ejecting position 114 of the staple magazine 121, so the foremost staple 16 is always ejected from the ejecting position 114. When the percussive force is ceased, the head of the main body 11 and the driver 113 are rebounded to their upper position driven by the tension of the leaf spring 111. In the meantime, the next foremost staple 16 will be pushed forward to the ejecting position 114 again to ready for the next punching.

FIG. 4 shows an exploded view of the linkage built-in hammer tacker 2. Similar to the aforesaid non-linkage hammer tacker 1, the linkage built-in hammer tacker 2 also includes a main body 21, a magazine assembly 22, a pusher assembly 23, a pivot pin 24 and a handle grip 25; wherein, the rear end of the main body 21 is engaged with rear end of the magazine assembly 22 pivotally by using the pivot pin 24, so that the handle grip 25 can be sheathed onto the assembly. The difference between the non-linkage hammer tacker 1 and the linkage built-in hammer tacker 2 is that the linkage built-in hammer tacker 2 includes a linkage mechanism comprising a compression spring 211 and a four-bar linkage 212 to produce a mechanical movement for driving the staples and the elastic rebound of the tacker 2. As shown in FIGS. 5 and 6, the driven crank of the four-bar linkage 212 is connected to the compression spring 211, and the driving crank is connected to a driver 213 installed in the main body 21, so that the driver 213 will be positioned at the upper position and lower position elastically during the operating processes. Moreover, a staple magazine 221 is formed along the longitudinal length of the magazine assembly 22, which provides the U-shaped staples 26 to be fed from its transverse direction along the staple magazine 221, and the staples 26 will be pushed ahead elastically by virtue of the pusher assembly 23 to the front ejecting position 214 of the magazine assembly 22. Likewise, the pusher assembly 23 also includes a pushing rod 231, a pushing guide 232, a rear cover 233 and an adjustable spring 234 sheathed on the pushing rod 231, and similar to the non-linkage hammer tacker 1, the foremost staple 26 is always pushed forward to the front ejecting position 214 of the staple magazine 221 (as shown in FIG. 5).

For illustration purpose, FIG. 5 shows a cross-sectional view of the linkage built-in hammer tacker 2, illustrating the position of the tacker before it is hammered, and FIG. 6 shows a cross-sectional view of the linkage built-in hammer tacker 2, illustrating the position of the tacker after it is hammered. As shown in the FIG. 5, before the staple 26 is punched, the assembly of the main body 21 and the magazine assembly 22 are located at the starting position and its head stays in an opening wide position because of the elasticity of the compression spring 211 and the four-bar linkage 212; meanwhile, the staples 26 are being pushed forward to the front ejecting position 214 of the staple magazine 221 by means of the pusher assembly 23, which is functioned by the tension of the adjustable spring 234 , as to the driver 213 which is located at the upper position of the ejecting position 214. When the user holds the handle grip 25 of the tacker 2 to hammer an object, as shown in FIG. 6, the head of the tacker 2 strikes down and hits the object, due to the transmission of the force, the driver 213 of the main body 21 therefore strikes the foremost U-shaped staple 26 which is conveyed to the front ejecting position 214 of the staple magazine 221, so the foremost staple 26 is always ejected from the ejecting position 214. When the percussive force is ceased, the head of the main body 21 and the driver 213 are rebounded to their upper position driven by the tension of the compression spring 211 and the four-bar linkage 212. In the meantime, the next foremost staple 26 has been pushed forward to the ejecting position 214 again to ready for the next punching.

However, the aforesaid two kinds of conventional hammer tackers have contained some improvable defects, such as:
1. Lack of the warning feature: Because the conventional hammer tackers have no warning feature, the user can not receive a warning before the staples run out. If the user persists working, he will not stop until he finds out there is no more staple in staple magazine, so hits without staples is not avoidable.
2. High possibility of staple jam: When the tacker strikes without staples for many times, or strikes continuously until only one or two pieces of staples left, this will cause the ejecting opening of the staple magazine becomes wider, and one of the last two staples will then be blocked in such opening and result in the staple jam of the tacker.
3. Low working efficiency and high energy wastage: Since the conventional hammer tackers can not avoid the hammering without staples, it leads to the wastage of labor and the low quality of works. Moreover, the staple jam will result in low working efficiency and damage on the tacker, therefore the life of the tacker becomes shorter.

The present invention is intended to improve the above mentioned drawbacks of the conventional hammer tackers by providing improved solutions to the problems of low working efficiency, high energy wastage, shortcoming of staple jam, etc.

### BRIEF SUMMARY OF THE INVENTION

The present invention relates to a hammer tacker having a warning device operating in sound or light effect when few U-shaped staples left during the working process, including an electric box having a buzzer or a light emitting diode (LED) and at least one battery, with both are conducted to each other by the electric wires. A reed switch located near the end route of the U-shaped staples is installed in the tacker and is also conducted by the electric wires to the buzzer or the light emitting diode (LED), the battery as well as the metallic shell. Furthermore, a reed is formed on the top of pushing guide of the pusher assembly. At the moment of the staples left with only as few as five staples, the reed on the pushing guide will touch the switch accordingly, so that the circuit will become a circuit loop and the buzzer will buzz or the light emitting diode (LED) will glitter to remind the user to reload the staples.

In light of the above, the advantages of the present invention include:
1. Because the present invention involves a design, which can warn or remind the user beforehand to reload the U-shaped staples when there are few left, it will avoid the wastage of labor which caused by the unknowing of the running out of the staples.
2. Because the present invention can provide a warning signal before running out the staples while reminding the user to reload the same, it is unlikely that the tacker will end up with one or two pieces of staples left in the staple magazine, causing the staple jam in the ejecting opening of the staple magazine. In short, the tacker can function normally.
3. Because the present invention can function as a precaution measure to remind the user to reload the U-shaped staples to avoid the staples jam. Therefore the working efficiency and the quality of works will be enhanced accordingly, and the use life of the hammer tacker is prolonged as well.

The features and advantages described in the specification are not all inclusive. Particularly, many additional features and advantages will be apparent to one with ordinary skill in the art in view of the drawings, specification and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is is an exploded view schematically showing the conventional non-linkage hammer tacker;

FIG. 2 is a cross-sectional view schematically showing the conventional non-linkage hammer tacker, illustrating the position of the tacker before it is hammered;

FIG. 3 is a cross-sectional view schematically showing the conventional non-linkage hammer tacker, illustrating the position of the tacker after it is hammered;

FIG. 4 is an exploded view schematically showing the conventional linkage built-in hammer tacker;

FIG. 5 is a cross-sectional view schematically showing the conventional linkage built-in hammer tacker, illustrating the position of the tacker before it is hammered;

FIG. 6 is a cross-sectional view schematically showing the conventional linkage built-in hammer tacker, illustrating the position of the tacker after it is hammered;

FIG. 7 is an overall perspective view schematically showing the assembly of an embodiment of the warning device used in the linkage built-in hammer tacker of the present invention;

FIG. 8 is an exploded view schematically showing the warning device used in the non-linkage hammer tacker of the present invention;

FIG. 9 is a cross-sectional view schematically showing the reed switch used in the non-linkage hammer tacker of the present invention;

FIG. 10 is a circuit diagram for the embodiment shown in the FIG. 8 of the present invention;

FIG. 11 is a cross-sectional view schematically showing the non-linkage hammer tacker of the present invention, illustrating the position of the tacker before it is hammered;

FIG. 12 is a cross-sectional view schematically showing the non-linkage hammer tacker of the present invention, illustrating the position of the tacker after it is hammered;

FIG. 13 is a partial cross-sectional view schematically showing another aspect which a light emitting diode (LED) is used in the non-linkage hammer tacker of the present invention;

FIG. 14 is an overall perspective view schematically showing the assembly of the another embodiment of the warning device used in the linkage built-in hammer tacker of the present invention;

FIG. 15 is an exploded view schematically showing the warning device used in the linkage built-in hammer tacker of the present invention;

FIG. 16 is a cross-sectional view schematically showing the reed switch used in the linkage built-in hammer tacker of the present invention;

FIG. 17 is a cross-sectional view schematically showing the linkage built-in hammer tacker of the present invention, illustrating the position of the tacker before it is hammered;

FIG. 18 is a cross-sectional view schematically showing the linkage built-in hammer tacker of the present invention, illustrating the position of the tacker after it is hammered;

FIG. 19 is a partial cross-sectional view schematically showing another aspect which a light emitting diode (LED) is used in the linkage built-in hammer tacker of the present invention.

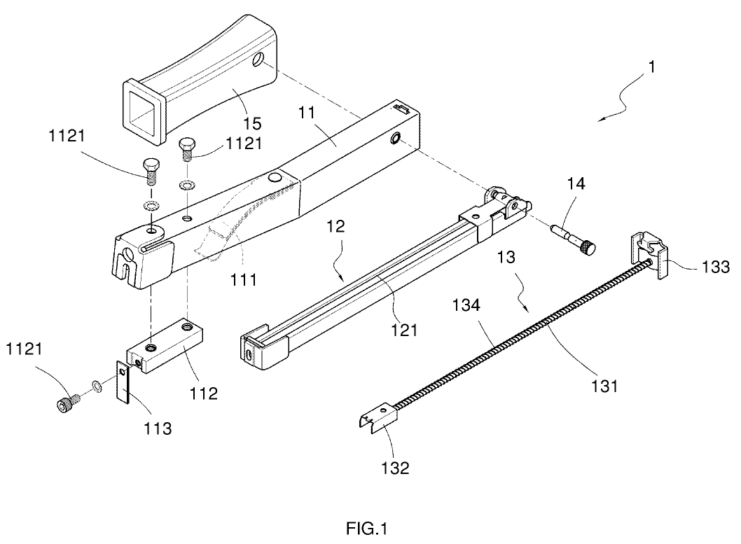

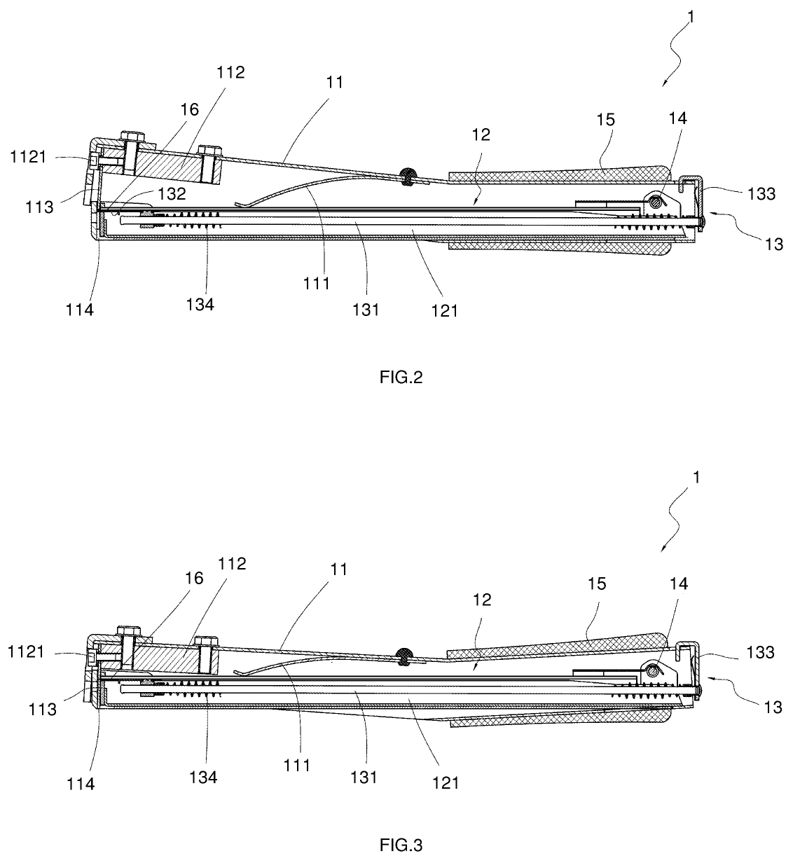

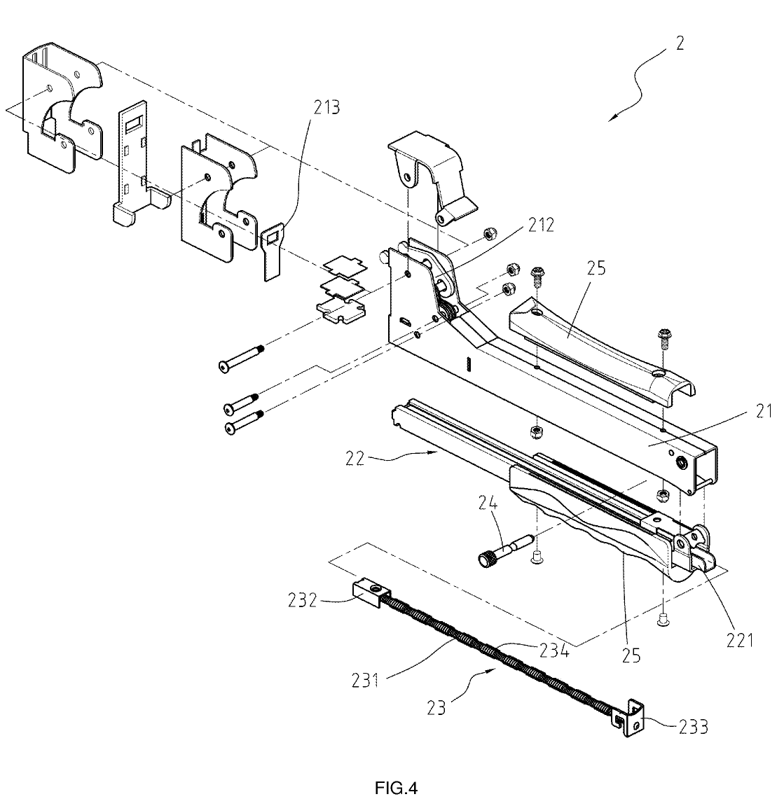

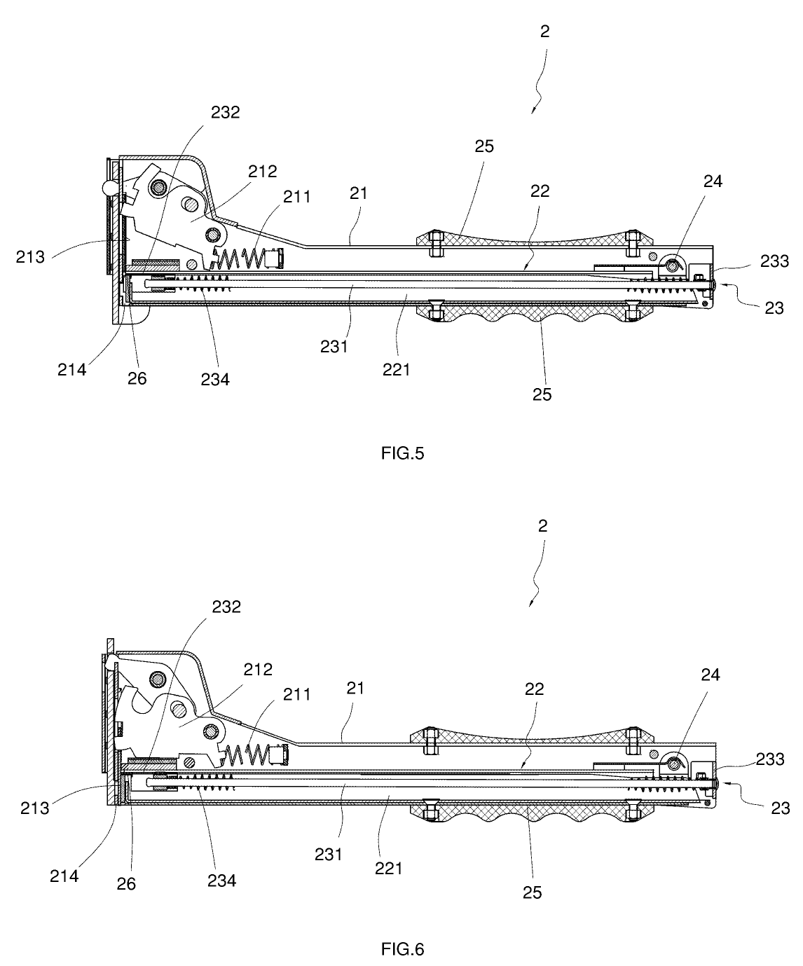

### DETAILED DESCRIPTION OF THE INVENTION

The drawings depict various preferred embodiments of the present invention for purposes of illustration only. One skilled in the art will readily recognize from the following discussion that alternative embodiments of the structures and methods illustrated herein may be employed without departing from the principles of the invention described herein.

The present invention relates to a warning device to alert the users to reload the staples on various types of manual hammer tackers by generating a warning sound effect with a buzzer or a warning light effect with a light emitting diode (LED) when only few U-shaped staples left during the working process.

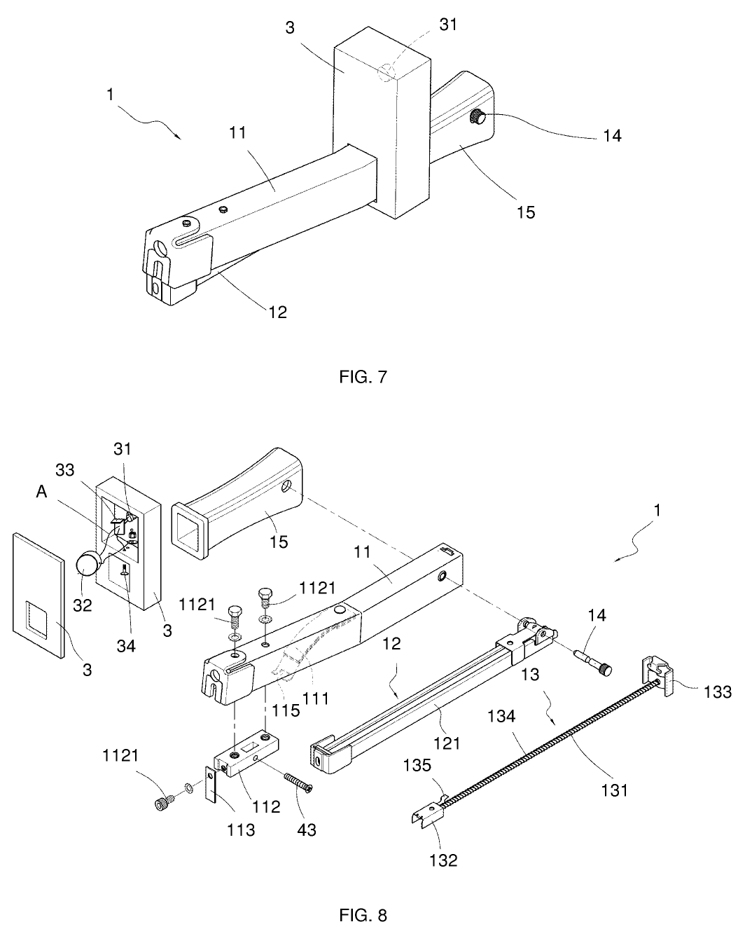

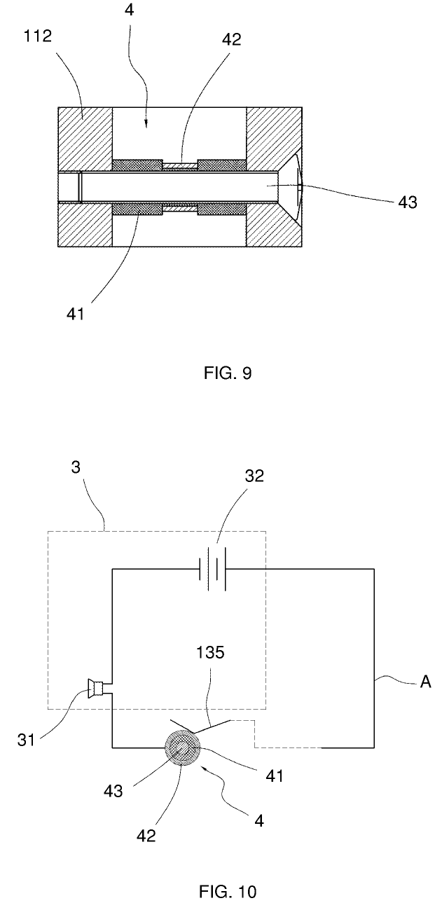

FIGS. 7 to 10 show an embodiment of the warning device used in a non-linkage hammer tacker of the present invention. Wherein, FIG. 7 shows a perspective view of the assembly, FIG. 8 shows an exploded view of the assembly, FIG. 9 shows a cross-sectional view of the reed switch, and FIG. 10 shows its circuit diagram. As aforementioned, the non-linkage hammer tacker 1 includes a main body 11, a magazine assembly 12, a pusher assembly 13, a pivot pin 14 and a handle grip 15; an electric box 3 is installed in front of the handle grip 15 and having a buzzer 31 and at least one battery 32 which are fixed in the box 3 by using the brackets 33 and the fasteners 34. One lead of the buzzer 32 is connected to an electrode of the battery 32 by using a electric wire A, and the other electrode of the battery 32 is connected to the metallic shell of the hammer tacker 1 by using the electric wire A as well. Furthermore, a reed switch 4 is installed in the tacker 1 and is near the end route of the U-shaped staples 16, while the reed switch 4 is mainly fixed inside the hollow space of the balancing piece 112, as shown in FIG. 9. The reed switch 4 includes an insulating sleeve 41 and an electric conducting ring 42 which is sheathed on the insulating sleeve 41. When the reed switch 4 is fixed onto the balancing piece 112 by a fastener 43, the electric conducting ring 42 will then be insulated from the surrounded metallic parts. Meanwhile, the electric conducting ring 42 is also connected to the other lead of the buzzer 31 by using the electric wire A. In addition, a reed 135 is formed on the back part of the pushing guide 132 of the pusher assembly 13. Once the reed 135 is touched with the reed switch 4, the circuit of the buzzer 31, battery 32 and the reed switch 4 becomes a circuit loop (as shown in FIG. 10), further to activate the buzzer 31 to create a sound effect. For preventing the reed 135 to be interfered by the leaf spring 111 when it moves forward on the rail of the staple magazine 121, an indentation is formed at the end of the leaf spring 111 to avoid the interference of the reed 135.

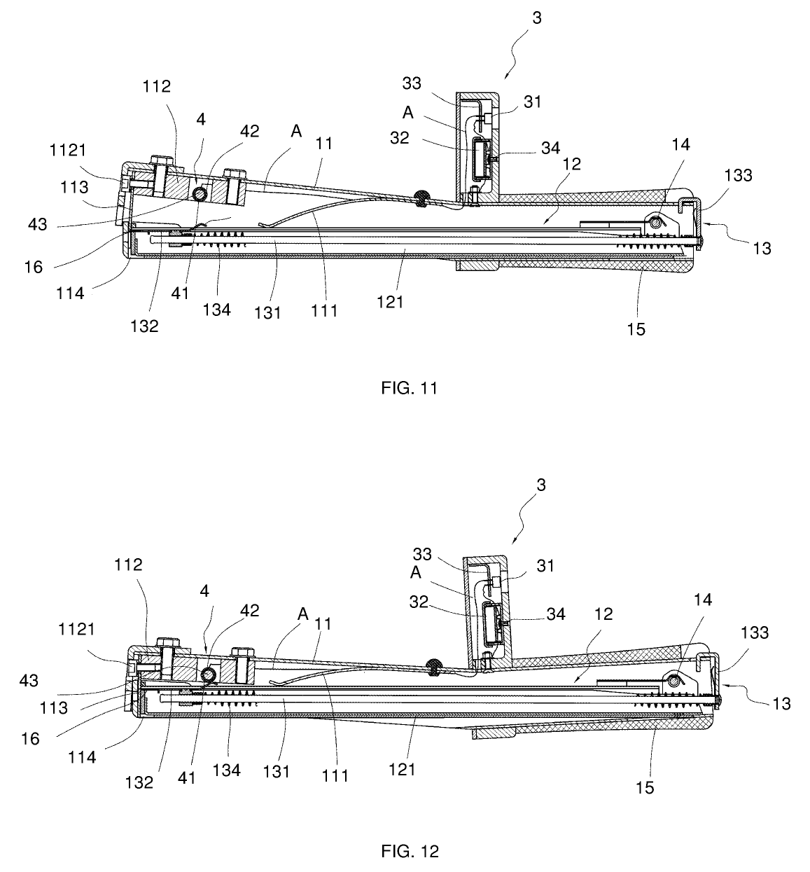

For the purposes of showing the practical use of the embodiment, FIG. 11 shows a cross-sectional view illustrating the position of the tacker 1 before the staple is punched, and FIG. 12 shows a cross-sectional view illustrating the position of the tacker 1 after the staple is punched. When the hammer tacker 1 is used in a normal working process, the U-shaped staples 16 are continuously punched out by the driver 113, and the staples 16 are also being pushed forwardly by the pushing guide 132, all due to the tension of the adjustable spring 134. When the staples 16 has been used and left a specific amount, for example five pieces, the pushing guide 132 will then be moved to the specific position at the same time, if the user hit the hammer tacker 1 once again (as shown in FIG. 12), the reed switch 4 which installed inside of the balancing piece 112 of the main body 11 will then be touched with the up-extending reed 135, and the circuit will be conducted and become a circuit loop, so as the buzzer 31 bursts out the buzz to remind the user to reload the staples 16. Nevertheless, when the staples 16 run out and the reed 135 passed by the reed switch 4, the circuit is no more conducted, so the buzz of the buzzer 31 will be ceased accordingly. As for the time of the buzz sound of the buzzer 31 can be determined by the time of touch between the reed 135 and the reed switch 4, so it is adjustable to further control the amount of the staples 16 and the time of warning.

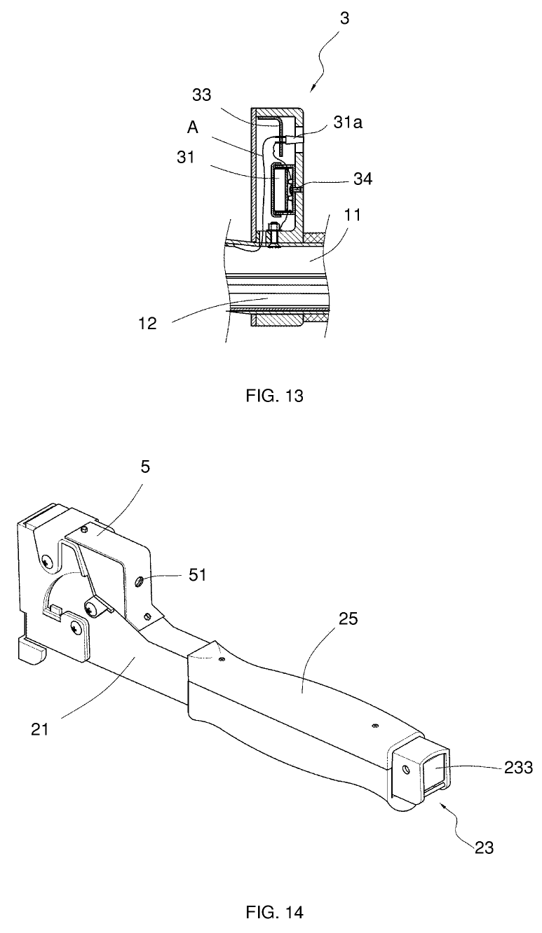

FIG. 13 shows the another aspect of the present invention which is used in the non-linkage hammer tacker 1, wherein, the sound warning device of buzzer 31 can be replaced by a light warning device of a light emitting diode (LED) (31a) to achieve the same warning function to the user; the technical methods and the structures which used in this aspect are identical to the one used in the buzzer 31.

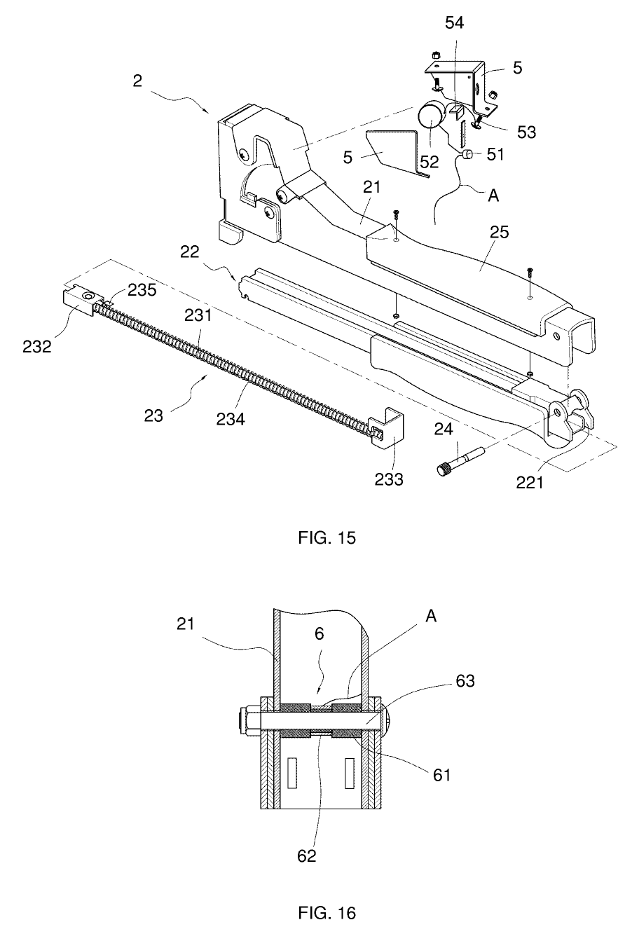

FIGS. 14 to 16 show another embodiment of the warning device used in a linkage built-in hammer tacker of the present invention. Wherein, FIG. 14 shows a perspective view of the assembly, FIG. 15 shows an exploded view of the assembly, and FIG. 16 shows a cross-sectional view of the reed switch. As aforementioned, the linkage built-in hammer tacker 2 includes a main body 21, a magazine assembly 22, a pusher assembly 23, a pivot pin 24 and a handle grip 25; an electric box 5 is installed on the rear part of the head of the main body 21 having a buzzer 51 and at least one battery 52 which are fixed in the box 5 by using the brackets 53 and the fasteners 54. One lead of the buzzer 52 is connected to an electrode of the battery 52 by using a electric wire A, and the other electrode of the battery 52 is connected to the metallic shell of the hammer tacker 2 by using the electric wire A as well. Furthermore, a reed switch 6 is installed in the tacker 2 and is near the end route of the U-shaped staples 26, and the reed switch 6 is mainly fixed onto a ply-metal within the head of the main body 21, as shown in FIG. 16. The reed switch 6 includes an insulating sleeve 61 and an electric conducting ring 62 which is sheathed on the insulating sleeve 61, when the reed switch 6 is fixed inside of the ply-metal of the main body 21 by a fastener 63, the electric conducting ring 62 will then be insulated from the surrounded metallic parts. Meanwhile, the electric conducting ring 62 is also connected to the other lead of the buzzer 51 by using the electric wire A. In addition, a reed 235 is formed on the back part of the pushing guide 232 of the pusher assembly 23, when the reed 235 is touched with the reed switch 6, the circuit of the buzzer 51, battery 52 and the reed switch 6 becomes a circuit loop (as shown in FIG. 10), further to activate the buzzer 31 to create the sound effect.

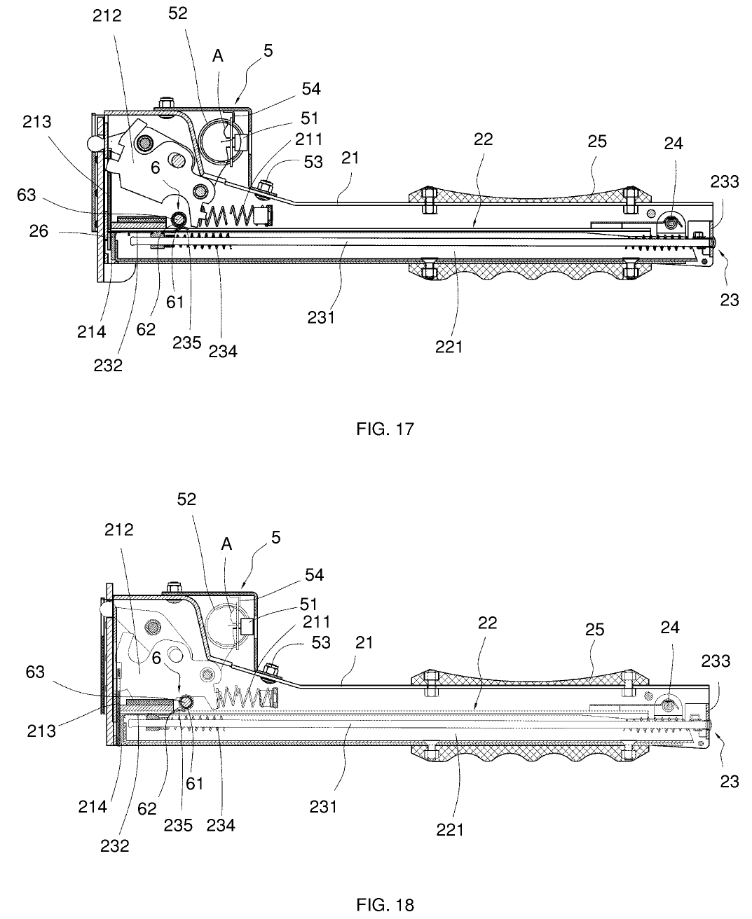

For the purposes of showing the practical use of the embodiment, FIG. 17 shows a cross-sectional view illustrating the position of the tacker 2 before the staple is punched, and FIG. 18 shows a cross-sectional view illustrating the position of the tacker 2 after the staple is punched. When the hammer tacker 2 is used in a normal working process, the U-shaped staples 26 are continuously punched out by the driver 213, and the staples 26 are also being pushed forwardly by the pushing guide 232 due to the tension of the adjustable spring 234, when the staples 26 has been used and few pieces left, for example five pieces, the pushing guide 232 will then be moved to the specific position at the same time, the up-extending reed 235 will then be touched with the reed switch 6 (as shown in FIG. 17), and the circuit will be conducted and become a circuit loop, so as the buzzer 51 bursts out the buzz to remind the user to reload the staples 26. Nevertheless, when the staples 26 run out and the reed 235 passed by the reed switch 6, and the circuit is no more conducted, so the buzz of the buzzer 51 will be ceases accordingly (as shown in FIG. 18). As for the time of the buzz sound of the buzzer 51 can be determined by the time of touch between the reed 235 and the reed switch 6, so it is adjustable to further control the amount of the staples 26 and the time of warning.

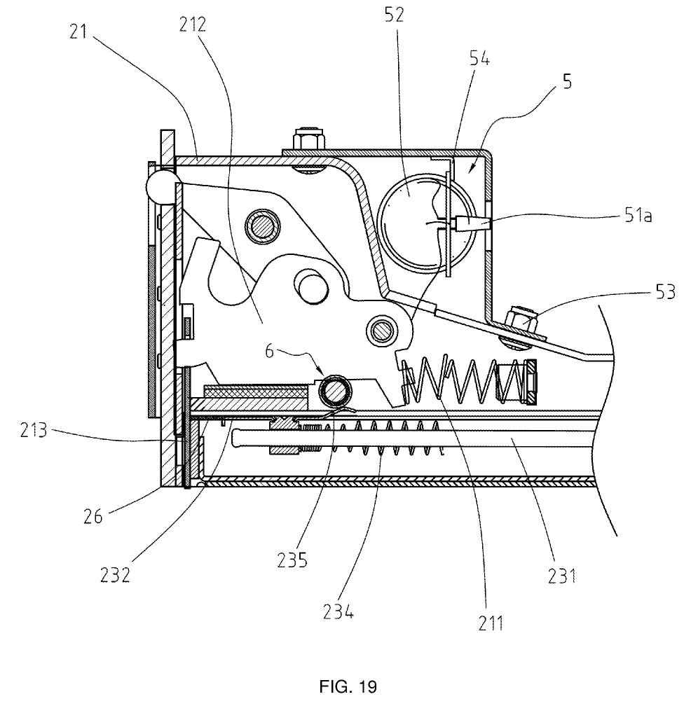

FIG. 19 shows the another aspect of the present invention used in the linkage built-in hammer tacker 2, wherein, the sound warning device of buzzer 51 can be replaced by a light warning device of a light emitting diode (LED) (51a) to achieve the same warning function to the user; the technical methods and the structures which used in this aspect are identical to the one used in the buzzer 51.

From the above description, it is obvious that the invention disclosed herein provides a novel and advantageous warning device installed in various hammer tackers providing a precaution to the user to reload the staples. The foregoing discussion discloses and describes merely exemplary embodiments of the present invention. As will be understood by those familiar with the art, the invention may be embodied in various other forms without departing from the spirit or essential characteristics thereof. Accordingly, the disclosure of the present invention is intended to be illustrative, but not limiting, of the scope of the invention, which is set forth in the following claims.

What is claimed is:

1. A manual hammer tacker comprising:
a tacker includes a main body, a magazine assembly, a pusher assembly, a pivot pin and a handle grip; wherein, the rear end of the main body is engaged with the rear end of the magazine assembly pivotally by using the pivot pin, so that the handle grip is sheathed onto the assembly; an elastomer is installed inside of the main body and is used to provide an elastic counterforce when the motion of punching a staple is completed; a driver is fixed onto the head of the main body and forms a main feature of the tacker; a staple magazine is formed along the longitudinal length of the magazine assembly and provides the U-shaped staples to be fed from its transverse direction along the staple magazine; meanwhile, the staples are always pushed ahead elastically by virtue of the pusher assembly, so that a foremost staple is situated at the ejecting position of the tacker to provide a hammering motion driven by the driver; the pusher assembly contains a pushing rod, a pushing guide, a rear cover and an adjustable spring sheathed on the pushing rod; wherein, the pushing rod and the rear cover are welded to form as one, and the pushing guide is attached to the front end of the adjustable spring so that the pushing guide is slid along the pushing rod elastically;
an electric box is installed on the hammer tacker;
a warning device is installed in the electric box;
at least one battery coupled with the warming device is installed in the electric box;
a reed switch conducted with the warning device, battery and the metallic shell of the hammer tacker by using the electric wires is installed in the tacker near the end route of the U-shaped staples; and
a reed formed on the pushing guide of the pusher assembly is touched with the reed switch when the staples are pushed forward and left with a specific amount; the circuit then becomes a circuit loop, further to activate the warning device to remind the user to reload the staples.

2. A hammer tacker as recited in claim 1 wherein one lead of the warning device is connected to an electrode of the battery by using a electric wire, and the other electrode of the battery is connected to the metallic shell of the hammer tacker by using the electric wire as well; furthermore, the reed switch is connected to the other lead of the warning device by using the electric wire; when the reed on the pushing guide is touched with the reed switch, the circuit of the warning device, battery and the reed switch becomes a circuit loop.

3. A hammer tacker as recited in claim 1 wherein the reed switch contains an insulating sleeve and an electric conducting ring where the electric conducting ring is sheathed on the insulating sleeve, so that the electric conducting ring is insulated from the surrounded metallic parts.

4. A hammer tacker as recited in claim 1 wherein the warning device is a buzzer.

5. A hammer tacker as recited in claim 1 wherein the warning device is a light emitting diode (LED).

6. A manual non-linkage hammer tacker comprising:
a tacker includes a main body, a magazine assembly, a pusher assembly, a pivot pin and a handle grip; wherein, the rear end of the main body is engaged with the rear end of the magazine assembly pivotally by using the pivot pin, so that the handle grip is sheathed onto the assembly; a leaf spring is installed inside of the main body which is used to provide an elastic counterforce when the motion of punching a staple is completed; a balancing piece and a driver are fixed onto the inner front end of the main body and form a main feature of the tacker; a staple magazine is formed along the longitudinal length of the magazine assembly to provide the U-shaped staples to be fed from its transverse direction along the staple magazine; meanwhile, the staples are always pushed ahead elastically by virtue of the pusher assembly, so that a foremost staple is always situated at the ejecting position of the tacker to provide a hammering motion driven by the driver; the pusher assembly contains a pushing rod, a pushing guide, a rear cover and an adjustable spring sheathed on the pushing rod; wherein, the pushing rod and the rear cover are welded to form as one, and the pushing guide is attached to the front end of the adjustable spring, so that the pushing guide is slid along the pushing rod elastically;
an electric box is installed in front of the handle grip;
a warning device is installed in the electric box;
at least one battery coupled with the warming device is installed in the electric box;
a reed switch conducted with the warning device, battery and the metallic shell of the hammer tacker by using the electric wires is installed inside of the hollow space of the balancing piece near the end route of the U-shaped staples; and
a reed formed on the back part of the pushing guide of the pusher assembly is touched with the reed switch when the staples are pushed forward and left with a specific amount, the circuit of the warning device, battery and the reed switch then becomes a circuit loop, further to activate the warning device to remind the user to reload the staples.

7. A non-linkage hammer tacker as recited in claim 6 wherein one lead of the warning device is connected to an electrode of the battery by using a electric wire, and the other electrode of the battery is connected to the metallic shell of the hammer tacker by using the electric wire as well; furthermore, the reed switch is connected to the other lead of the warning device by using the electric wire; when the reed on the pushing guide is touched with the reed switch, the circuit of the warning device, battery and the reed switch becomes a circuit loop.

8. A non-linkage hammer tacker as recited in claim 6 wherein the reed switch contains an insulating sleeve and an electric conducting ring where the electric conducting ring is sheathed on the insulating sleeve, so that the electric conducting ring is insulated from the surrounded metallic parts.

9. A non-linkage hammer tacker as recited in claim 6 wherein the warning device is a buzzer.

10. A non-linkage hammer tacker as recited in claim 6 wherein the warning device is a light emitting diode (LED).

11. A non-linkage hammer tacker as recited in claim 6 wherein an indentation is formed at the end of the leaf spring to prevent the reed to interfer by the leaf spring when it moves forward on the rail of the staple magazine.

12. A manual linkage built-in hammer tacker comprising:
a tacker includes a main body, a magazine assembly, a pusher assembly, a pivot pin and a handle grip; wherein, the rear end of the main body is engaged with the rear end of the magazine assembly pivotally by using the pivot pin, so that the handle grip is sheathed onto the assembly; a linkage mechanism is installed in the main body comprising a compression spring and a four-bar linkage, which is used to produce a mechanical movement for driving a staple and then the elastic rebound of the tacker; and a driver is connected to the linkage mechanism and forms a main feature of the tacker; a staple magazine is formed along the longitudinal length of the magazine assembly to provide the U-shaped staples to be fed from its transverse direction along the staple magazine; meanwhile, the staples are always pushed ahead elastically by virtue of the pusher assembly, so that a foremost staple is always situated at the ejecting position of the tacker to provide a hammering motion driven by the driver; the pusher assembly contains a pushing rod, a pushing guide, a rear cover and an adjustable spring sheathed on the pushing rod; wherein, the pushing rod and the rear cover are welded to form as one, and the pushing guide is attached to the front end of the adjustable spring, so that the pushing guide is slid along the pushing rod elastically;
an electric box is installed on the rear part of the head of the main body;
a warning device is installed in the electric box;
at least one battery coupled with the warming device is installed in the electric box;
a reed switch conducted with the warning device, battery and the metallic shell of the hammer tacker by using the electric wires is installed onto a ply-metal within the head of the main body near the end route of the U-shaped staples; and
a reed formed on the back part of the pushing guide of the pusher assembly is touched with the reed switch when the staples are pushed forward and left with a specific amount, the circuit of the warning device, battery and the reed switch then becomes a circuit loop, further to activate the warning device to remind the user to reload the staples.

13. A linkage built-in hammer tacker as recited in claim 12 wherein one lead of the warning device is connected to an electrode of the battery by using a electric wire, and the other electrode of the battery is connected to the metallic shell of the hammer tacker by using the electric wire as well; furthermore, the reed switch is connected to the other lead of the warning device by using the electric wire; when the reed on the pushing guide is touched with the reed switch, the circuit of the warning device, battery and the reed switch becomes a circuit loop.

14. A linkage built-in hammer tacker as recited in claim 12 wherein the reed switch contains an insulating sleeve and an electric conducting ring where the electric conducting ring is sheathed on the insulating sleeve, so that the electric conducting ring is insulated from the surrounded metallic parts.

15. A linkage built-in hammer tacker as recited in claim 12 wherein the warning device is a buzzer.

16. A linkage built-in hammer tacker as recited in claim 12 wherein the warning device is a light emitting diode (LED).
